(19) United States
(12) Patent Application Publication
(10) Pub. No.: US 2009/0037114 A1
(43) Pub. Date: Feb. 5, 2009

(54) 4D+ PRESTACK SEISMIC DATA STRUCTURE, AND METHODS AND APPARATUS FOR PROCESSING 4D+ PRESTACK SEISMIC DATA

(76) Inventors: CHENGBIN PENG, Sugar Land, TX (US); Sebastien Vautier, Houston, TX (US)

Correspondence Address: GILBRETH & ASSOCIATES, P.C., PO BOX 2428, BELLAIRE, TX, 77402-2428, US

(21) Appl. No.: 11/829,982

(22) Filed: Jul. 30, 2007

(51) Int. Cl. G01V 1/28

(52) U.S. Cl. 702/14

(57) ABSTRACT

Methods, apparatus and products for processing 4D+ prestack seismic data having the form of 3D prestack gathers, single fold 3D volumes, and a mapping table to link the gathers and the volumes coherently.

### BACKGROUND

1. Field of the Invention

The present invention relates to methods, apparatus, and products relating to seismic data, seismic data collection, seismic exploration, seismic processing, and seismic interpretation. In another aspect, the present invention relates to methods, apparatus, and products relating to high dimensional seismic data, for processing such data, and to interpreting such data. In even another aspect, the present invention relates to methods, apparatus, and processes for interpreting migrated seismic volumes for deriving subsurface information from seismic wave measurements taken at the earth's surface or in a wellbore, including processes for employing prestack seismic data for structural mapping, reserves estimation, pore pressure prediction, lithology and fluid prediction, well placement and reservoir monitoring using repeated seismic surveys.

2. Description of the Related Art

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The Oil and Gas industry has an urgent need for technologies that help reduce the risk and uncertainty in finding and qualifying reserves. Part of that challenge is the integration of new information when it becomes available and making use of it in a timely fashion. A technology that allows rapid visualization and interpretation of prestack migrated seismic data on an interpretation workstation would benefit the industry enormously. Interpretation of prestack seismic data is still not widely used in the industry primarily because of the sheer size of the input data involved and a lack of efficient tools to make the data readily usable. Some techniques of using prestack seismic data, will first reduce or compress the size of the prestack seismic data file. Certainly, some amount of information is lost by reducing or compressing the data file. Consequently, seismic interpretation is generally limited to smaller poststack data sets.

Significant advantages exist for extending interpretation and associated data manipulation to prestack data, including:
Prestack migrated seismic data contain additional information about subsurface lithologies and fluids that are difficult to obtain from stacked seismic data alone;
Prestack migrated seismic data can be used to diagnose and update the velocity model used to produce the migrated image;
Prestack migrated seismic data contain subsurface illumination information which varies from offset to offset, from angle to angle, and which is lost after being stacked; and/or,
Prestack migrated seismic data provide capabilities for additional noise attenuation, signal enhancement, and attribute extraction.

Harnessing the wealth of information from prestack migrated seismic data requires sophisticated data representation and data storage for rapid data access, retrieval, and update. Since prestack migrated seismic data are typically huge in size (of the order of terabytes), an intelligent scheme is needed to provide interpreters with many prestack seismic volumes without taxing disk storage and network traffic.

Some embodiments of the present invention may help solve these kinds of problems.

### SUMMARY OF THE INVENTION

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows

According to one non-limiting embodiment of the present invention, there is provided a data structure embedded in computer readable media, for 4D+ prestack seismic data. The structure may include volume fields containing data indicative of individual single fold 3-D volumes. The structure may also include gather fields associated with the volume fields, and containing data indicative of 3-D prestack gathers. The structure may also include mapping table fields containing data for linking the volume fields and the gather fields, and for maintaining coherency between the volume fields and the gather fields.

According to another non-limiting embodiment of the present invention, there is provided a data structure embedded in computer readable media, for 4D+ prestack seismic data. The structure may include a flag field containing data indicating the data structure as a phantom. The structure may also include a a pointer field containing data indicative of an association with at least one 4D+ prestack seismic data set. The structure may also include shell fields containing data indicative of a description of the data structure. The structure may also include ordered operation fields containing data indicative of ordered operations for generating data of the data structure from the at least one 4D+ prestack seismic data set.

According to even another non-limiting embodiment of the present invention, there is provided a computer implemented method of processing 4D+ prestack seismic data. The data may comprises individual single fold 3-D volumes, 3-D prestack gathers, and mapping data for linking the volumes and the gathers and for maintaining coherency between the volumes and gathers. The method comprises carrying out at least one processing operation on the 4D+prestack seismic data.

According to still another non-limiting embodiment of the present invention, there is provided a computer implemented method of processing 4D+ prestack seismic data. The data may comprise a flag indicating the data as phantom, a pointer to at least one 4D+ prestack seismic data set, a description of the data structure, and/or an ordered operation for generating data from the at least one 4D+ prestack seismic data set. The method may include carrying out at least one processing operation on the 4D+ prestack seismic data.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 depicts a NexusHyperCube on storage media; a volumes/gathers dual representation.

FIG. 2 is a flowchart of Voxet and HyperVoxet Diagrams showing overloaded components.

FIG. 3 is a flowchart depicting the Phantom NexusHyperCube process flow.

FIG. 4 depicts a NexusHyperCube representation that shows a single offset volume.

FIG. 5 depicts a NexusHyperCube representation that shows a single gather view intersected with an offset view.

FIG. 6 depicts a phantom NexusHyperCube pointing to single root NexusHyperCube.

FIG. 7 depicts a phantom NexusHyperCube pointing to a phantom NexusHyperCube which is pointing to a single root NexusHyperCube.

FIG. 8 depicts a phantom NexusHyperCube pointing to more than one root NexusHyvperCuheb

FIG. 9 depicts a phantom NexusHyperCube pointing to a phantom NexusHyperCube and a root NexusHyperCube.

### DETAILED DESCRIPTION OF THE INVENTION

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

Many of the embodiments of the present invention are illustrated by use of the commercially available GOCAD® geological modeling software, available from Paradigm Geophysical. Details regarding the GOCAD® geological modeling software may be found in the GOCAD Developer's Guide, at www.earthdecisionsciences.com, both of which are herein incorporated by reference. However, it should be understood that the present invention may be carried out through the use of any suitable geological modeling software, whether commercially available software, proprietary software, or any other software. As non-limiting examples, other geological modeling software include Halliburton's Geoprobe and Landmark software and Schlumberger's Geoquest and Petrel software.

The present invention discloses novel data models for representing high dimensional prestack seismic data and associated storage. These modes may be utilized to process the seismic data, with such processing operations including any signal processing operation and any non-signal processing operation. As used herein, a signal processing operation is any mathematical operation that may be carried out on the seismic data. A non-signal processing operation may be any non-mathematical operation carried out on the seismic data, non-limiting examples of which include but are not limited to copying, viewing, writing, displaying, transferring, picking, printing, extracting, cutting, splicing, or marking.

One or more of the embodiments of the models may provide:
dual data representations for fast access to both individual single fold 3D volumes (volume form) and 3D prestack gathers (gather form), plus a mapping table to link the two forms coherently;
regeneration of a single representation from its dual form, that is, carrying out an operation on either the gather or volume forms to maintain coherency between them;
a header table to annotate the additional dimension(s). The additional dimension(s) can be scalar (e.g., acquisition offset, acquisition azimuth, reflection angle, reflection azimuth, time stamps, or data vintages) or vector (such as [acquisition offset, acquisition azimuth] pair, [reflection angle, reflection azimuth] pair, or [time stamp, offset] pair, and so on);
a survey adaptor for converting among global coordinate (geographic coordinate), local coordinate (processing coordinate), and user coordinate (interpreter's inline and crossline numbers);
a scalar table to allow amplitude recovery for data stored on disk with reduced precision (e.g., 8-, 16-, or 32-bit storage of data that were originally 32-bit or 64-bit);
a header block to store dimensions, size, and characteristics of the data; and/or
a set of interface functions to read, write, or update prestack seismic data.

The model described above may be referred to herein as a “NexusHyperCube.” The dual data representations can be extended to triple/quadruple representations for higher dimension seismic data.

The NexusHyperCube may be described as a 4D object with the first three dimensions typically defining location (x, y, and z or t) and the fourth dimension being any other property, non-limiting examples of which include offset, angle, elapsed time, or version/vintage. It may have a dual representation: as a collection of volumes and as a collection of gathers (each gather is a subset of such a 4D object for a fixed (x,y) surface location.). This may facilitate real-time access to the extra dimension.

With some embodiments of the present invention, a prestack seismic data volume may be represented as a NexusHyperCube. In more detail, the NexusHyperCube may be described as an IHS model for 4+D prestack seismic data representation and storage. A NexusHyperCube includes (at least) two representations: a volume form and a gather form. Information for mapping between the forms is stored separately. Any single representation of a NexusHyperCube can be generated from its multiple forms. The additional dimension(s) beyond the three spatial (x, y, z) ones can be scalar (such as offset, reflection angle, time stamp, or data vintage/version) or vector (such as offset-azimuth pair). By spatial dimensions, it should be understood that a spatial dimension may be represented by units of length, non-limiting examples of which include feet, yards, miles, meters, km, or by units of time, non-limiting examples of which include seconds or milliseconds. The NexusHyperCube model allows fast access (read and write) to both individual single fold 3D volumes and 3D prestack seismic gathers and maintains data coherency among its representations. Thus, the NexusHyperCube model enables rapid visualization and manipulation of a prestack seismic data set on an interpretation workstation.

The NexusHyperCube model may utilize any desirable format. As a non-limiting example, the model may make use of public-domain formats for geomodeling objects, which allows reuse of existing visualization and manipulation functions with minimum adaptation. A non-limiting commercially available example is the GOCAD Voxet, which has proven to be a convenient basis for manipulating and visualizing 3D seismic and velocity data. Certainly, the present invention contemplates utilizing similar data representation in other commercial geomodeling software packages as well.

A NexusHyperCube is a 4+D seismic gather data set. Its format on computer readable media and its architecture are based on the Geomodeling Voxel Set format, a 3D seismic data model, hereinafter referred to as a Voxet. A NexusHyperCube uses two Voxets to represent the 4D gather data: the first Voxet is used to store “volume-packed” data (i.e. 3D volume carrying many properties, one for each acquisition offset, angle, etc.) the other storing “gather-packed” data (i.e. 2D gather data, one per trace, packed together in 3D Voxet properties, one per seismic line). The latter is an artificial representation supporting fast access to the gather data.

A Voxet may contain one or more property grids (called a Grid3d in GOCAD parlance), each of which has a DataCube and a DataStore. By extension, a NexusHyperCube may require a HyperDataCube and a HyperDataStore. All existing operations on, and visualization of, a Voxet may be directly applied to a NexusHyperCube without modification. This includes implicit handling of large data volumes using the “brick” mechanism currently supported by some geomodeling software. A NexusHyperCube API (Application Programming Interface) encapsulates internal data store and data dependency. Consequently, application developers only see the physical NexusHyperCube through the use of the API.

The NexusHyperCube may support storing property grids in any suitable or desirable format, non-limiting examples include 8-bit, 16-bit, or 32-bit format, and on any suitable data storage media. If needed to recover property values, a scalar may be applied on-the-fly if the property kind is set to linear (the scalar may be set to default at 1.0 for any selected data format, for example, if the data are stored with 32-bit precision.

Prestack seismic data may be loaded into the NexusHyperCube by any using any suitable method or software. As non-limiting examples, prestack seismic data may be loaded into NexusHyperCube from SEGY files and from Voxet volumes.

For SEGY data loading into the NexusHyperCube, any suitable data format may be utilized, non-limiting examples of which include 32 bit float, 32 bit integer, 16 bits, or 8 bits. SEGY trace headers can easily be mapped, and amplitude scalars can easily be handled correctly if the input data is 16 bits or 8 bits.

In loading Geomodeling Voxet data into a NexusHyperCube, the volume representation of the NexusHyperCube may be handled by a set of pointers to the original Voxet data. The gather representation of the NexusHyperCube may automatically be generated during the loading process.

The NexusHyperCube concept of the present invention may be implemented through the use of any suitable software. As a non-limiting example, the NexusHyperCube concept of the present invention may be implemented through the use of a new object, the HyperVoxet, which extends the Voxet object by adding meta data describing the relationship between property volumes in a Voxet.

In addition to the basic Voxet capabilities, the HyperVoxet may provide 4D-properties management and access, to map the NexusHyperCube concept onto a geomodeling-compliant store. A NexusHyperCube may be represented on any storage media as a set of 3D volumes, with each set having a different position in the 4th dimension. As a non-limiting example, in case of pre-stack data, each single volume may represent one common offset data. This volume set may also be represented by a gathers store, hence the dual representation of NexusHyperCube. Pre-stack gathers will be no less than a re-packing of the 3D volume along the 4th dimension. Pre-stack gathers are commonly visualized as 2D common trace diagrams juxtaposing the same trace viewed from different offsets. In order to benefit from the Voxet data accessor, these 2D gathers may be grouped by common inlines in a 3D Voxet storage mode.

This view may be easily extended from common offset to volume kind, non-limiting examples of which include common angle, common time stamp, or any other volume kind. In addition, the same storage mechanism may be used to exploit any 3D attribute computed from the seismic data (offset stacking, semblance, etc).

This dual representation may help achieve fast 4D access while using the already existing Voxet architecture. Under some embodiments of the present invention, the appropriate Voxet components are “overloaded” to enable the efficient handling of the NexusHyperCube data structure (implementing a new object or overloading an existing object implies providing commercial geomodeling software with all necessary information for its manipulation).

In spite of being a Voxet, the HyperVoxet will have its own identity. Suitable geomodeling software will match a HyperVoxet with a “Topological Object,” that is, the “real world” representation of an object and the link with its “physical description.” More specifically, it will map an N-dimensional object with N-dimensional property and region databases. Despite being a 4D concept, the HyperVoxet has a 3D geometry inherited from the Voxet, the 4th dimension being simulated by the way the 3D data is accessed.

While volume and gather requests may be addressed to the HyperVoxet, which will host the logic to switch between the two representations, the HyperVoxet Topological Object will create the appropriate HyperVoxet Property DB.

The HyperVoxet Property DB may add, remove, and list available HyperVoxet properties. These properties may be sorted by “volumes,” “gathers,” or “attributes” according to what their data represents.

The HyperVoxet Property DB may create the appropriate Hyper Data Cube and Hyper DataStore to access the data.

In some embodiments of the present invention, in order to optimize and monitor data access, as well as keep the NexusHyperCube dual representation synchronized, the Hyper Data Cube and Hyper Data Store may re-implement parts of the Voxet usual Data Cube and Data Store, such as multi-threaded access or performance tracking.

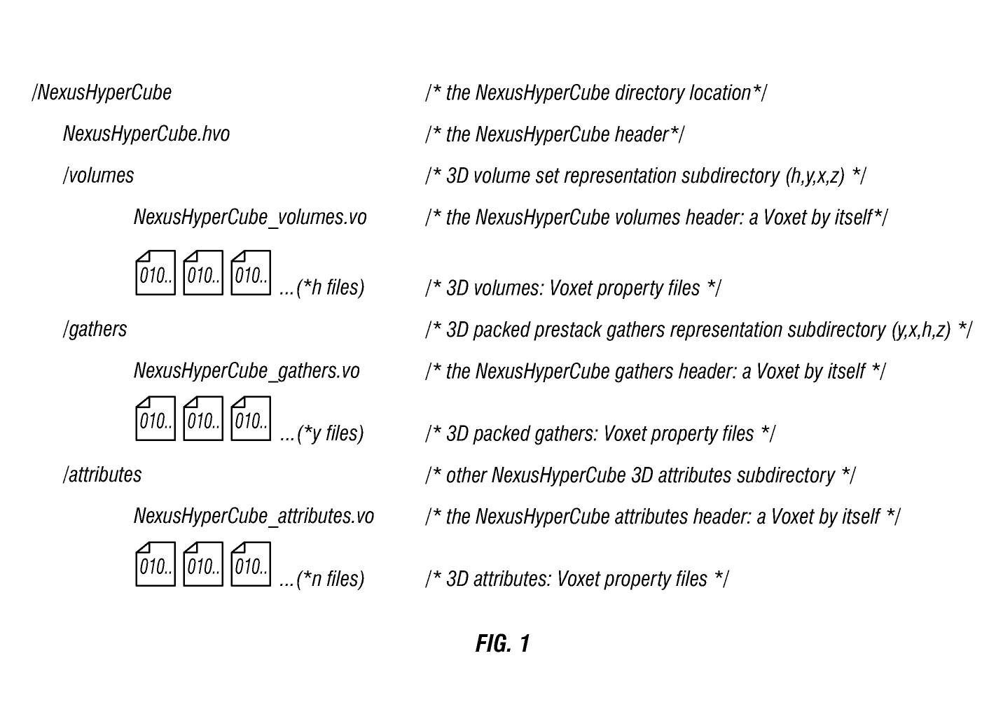

The current Voxet regions and Voxet model cover the HyperVoxet needs; for this reason, no particular region customization is required. The HyperVoxet will re-use the Voxet regions and model. Referring now to FIG. 1, there is shown a NexusHyperCube on computer-readable media, a volumes/gathers dual representation.

While relying on the Geomodeling ASCII and Archive mechanism for Voxet persistence, the HyperVoxet carries additional information which needs to be retained.

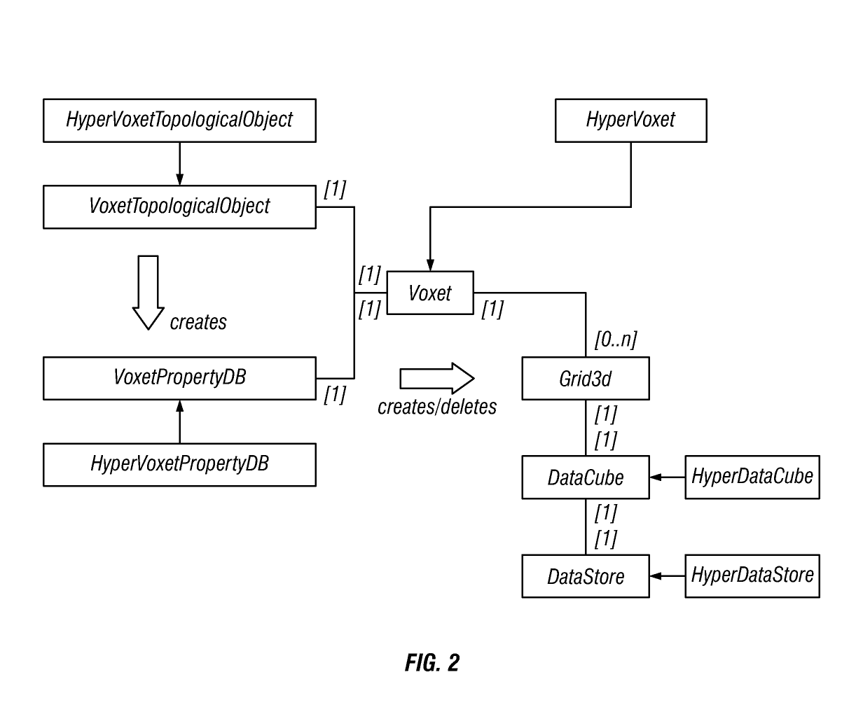

For the binary archive, some embodiments provide a new archive converter that may allow HyperVoxet specific information to be kept in Geomodeling projects. Nevertheless, inability to read the HyperVoxet information (when not using the Nexus extension to Geomodeling) should not prevent a user from using the underlying Voxet object in a conventional Geomodeling session. Referring now to FIG. 2, there is shown Voxet and HyperVoxet diagrams, showing overloaded components.

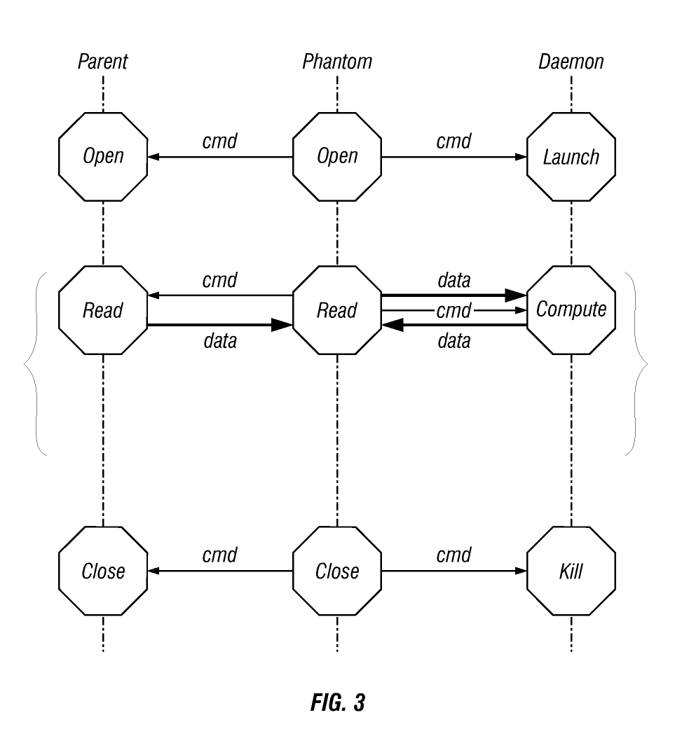

For ASCII files, the HyperVoxet may behave like a default Voxet. An additional option to read and write data from a NexusHyperCube (as described in FIG. 3) will be provided.

In some embodiments, the API (Application Program Interface) may provide a simple and stable interface for object manipulation. The HyperVoxet API may be used by Geomodeling Commands (CLI: Command Language Interface) and enable instructions to HyperVoxet object from the Geomodeling interface or a third party library. It may provide access to the tasks a HyperVoxet can perform or take part in. Because a HyperVoxet is also a Voxet, the HyperVoxet API inherits properties/characteristics from the Voxet API.

In some embodiments, the HyperVoxet may re-use the Voxet graphic view and manipulation as it is intended to behave the same way as, for example, a Voxet in GOCAD 3D and 2D cameras. Only a prestack gather window will offer additional visualization and manipulation capabilities.

In order to provide a user friendly environment for the new HyperVoxet object, such as contextual menus, drag-and-drops, key events, menu-bars, toolbars, or attributes, a new NexusHyperCube object may be integrated by the plug-in to the Geomodeling/GOCAD window. In some embodiments, the NexusHyperCube may inherit from most of the Voxet context, but may also provide the additional information contained in a HyperVoxet to the user.

Note that whereas the implementation object was named HyperVoxet, the user will directly manipulate the conceptual object: the NexusHyperCube.

To allow for vendor independent data sharing among applications (for example between the prestack interpretation plug-in and the prestack gather window), a NexusHyperCube API was integrated to the design of the plug-in. This API aims at separating Geomodeling dependent objects and concepts (Voxet, DataStore, etc.) from applications.

As used herein a “Phantom NexusHyperCube” is an abstraction of a real NexusHyperCube (may also be referred to as “non-phantom”) that may allow a given prestack seismic data set to have many different forms (polymorphism of prestack data). One or more embodiments of a Phantom NexusHyperCube may include: (1) a pointer to its parent NexusHyperCube (which can also be another Phantom NexusHyperCube); (2) a processing sequence or computational task attached; and (3) the same set of interface functions for reading prestack seismic data.

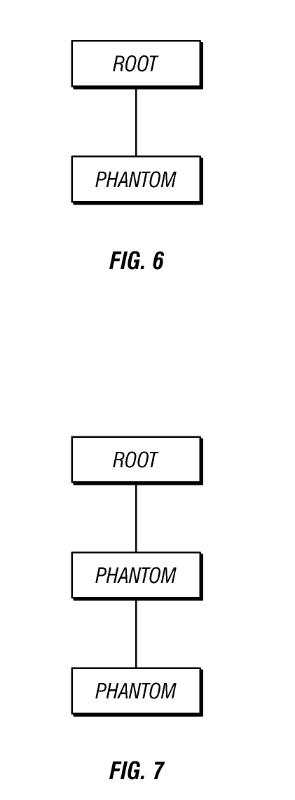

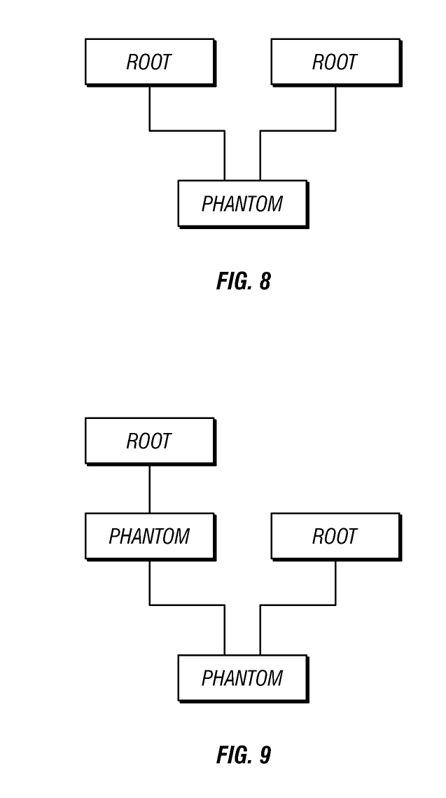

A Phantom NexusHyperCube may be completely derived from one or more NexusHyperCubes, Phantom NexusHyperCubes, or combinations thereof. Non-limiting examples of which are illustrated as follows: FIG. 6, phantom pointing to single root NexusHyperCube; FIG. 7, phantom NexusHyperCube pointing to a phantom NexusHyperCube which is pointing to a single root NexusHyperCube; FIG. 8, phantom NexusHyperCube pointing to more than one root NexusHyperCube; and FIG. 9, phantom NexusHyperCube pointing to a phantom NexusHyperCube and a root NexusHyperCube. As a non-limiting example, a Phantom NexusHyperCube may be derived from a Binary Phantom NexusHyperCube which has two parent NexusHyperCubes. The Phantom NexusHyperCube may be in a different form from its parent NexusHyperCube. As a non-limiting example, corresponding axes of the Phantom NexusHyperCube and the parent NexusHyperCube(s) may represent different items (as a non-limiting example its vertical axis may represent time, while its parent's may represent depth). The Phantom NexusHyperCube may be different in size and/or property type from its parent NexusHyperCube.

In some embodiments of the present invention, a Phantom NexusHyperCube may be used for: (1) Making a temporary copy of another NexusHyperCube without physically creating one; (2) Parameter testing for data processing, signal enhancement, muting, and other interpretive QC applications; (3) Making an under- or over-sampled copy of another NexusHyperCube without physically creating one: (4) Making a time or depth converted version of another NexusHyperCube without physically creating one; and/or (5) Making any derived NexusHyperCube as long as the operation involved in deriving the NexusHyperCube is limited enough to be practical.

Some of the embodiments of the present invention provide for saving disk storage, by not physically storing more than one copy of a prestack data set than is needed in visualization and interpretation of 4+D prestack seismic data.

More specifically, in some embodiments of the present invention, a Phantom NexusHyperCube may be used to achieve polymorphism of prestack seismic datasets without creating additional large disk files. A Phantom NexusHyperCube is a NexusHyperCube (4+D object) that can be completely derived from another NexusHyperCube or NexusHyperCubes via a sequence of on-the-fly signal processing operations. The root NexusHyperCube(s) must be a physical NexusHyperCube, but any or all of the intermediate parents can be Phantom NexusHyperCubes. The on-the-fly operations are implemented by background daemons that wake up when a request is received and sleep when there is nothing to be done. Many NexusHyperCubes can be present and loaded in a prestack seismic interpretation session but there may only be one or a few physical prestack seismic data sets (large in storage) on which these NexusHyperCubes are based. A Phantom NexusHyperCube shares the same user interface and user experiences but occupies little disk space, at the expense of extra computation. Thus, the Phantom NexusHyperCube model enables rapid visualization and manipulation of many prestack seismic data sets on an interpretation workstation.

A Phantom NexusHyperCube may comprise one or more of: (1) a shell, i.e., the meta file that describes the NexusHyperCube; (2) a reference to one or more [possibly phantom] NexusHyperCube; (3) ordered operations (names and parameters) for generating data in the NexusHyperCube; and/or (4) a flag to specify that this is a Phantom NexusHyperCube.

A non-limiting example of a Phantom NexusHyperCube is shown below:

<?xml version=“1.0” encoding=“ISO-8859-1” ?>
<nexus_hypercube xmlns:xsi=
“http://www.w3.org/2001/XMLSchema-instance”

| | xsi:noNamespaceSchemaLocation= | |
|---|---|---|
| | “/apps/template/nhm.xsd”> | |
| <version> | 0.1 | </version> |
| <name> | xxxx_lowfreq | </name> |
| <kind> | OFFSET | </kind> |
| <data_domain> Depth | | </data_domain> |
| <data_type> | DepthMigrated </data_type> | |
| <store> | PHANTOM | </store> |
| <grid> | | |

```
  <size noff=“40” nline=“366” ncdp=“699” nsamp=“1436”/>
  <origin foff=“1350.000000” fline=“4549” fcdp=“4089”
  fsamp=“0.000000”/>
  <step doff=“492.000000” dline=“2” dcdp=“2” dsamp=“32.000000”/>
</grid>
```

| | | |
|---|---|---|
| <parent> | /data/xxxx_kir.hvo | </parent> |
| <modules> | /data/lowpass.xml | </modules> |
| <gmapfile> | /data/xxxx_kir_gmap@@ | </gmapfile> |

</nexus_hypercube>

A Phantom NexusHyperCube can be saved in any desirable number of forms. As a non-limiting example, a “Shallow Save” will save the shell, reference and operations (names and parameters). As another non-limiting example, a “Deep Save” will convert to a physical NexusHyperCube.

For some embodiments of the present invention, a Phantom NexusHyperCube may be (1) spatially within or equal in size to its physical root NexusHyperCube; (2) under-sampled or over-sampled with respect to the physical NexusHyperCube; and/or (3) in different vertical domains (time or depth).

For some embodiments of the present invention, the NexusHyperCube and/or Phantom NexusHyperCube may form the foundation of a true prestack interpretation system. These coherent and compact representations of large prestack data sets may allow for efficient data management and allow for visualization and manipulation of the data. The NexusHyperCube and Phantom NexusHyperCube enable prestack seismic data interpretation, which is an extension of traditional interpretation of 3D stacked seismic data.

Some embodiments of the present invention provide for the extension of the NexusHyperCube model to storage and manipulation of wide-azimuth seismic data. Specifically, the extra dimension(s) represented in a NexusHyperCube may be a vector (for example, the acquisition-offset and acquisition-azimuth pair). Thus, the NexusHyperCube model can be extended to store and manipulate both migrated and unmigrated (but regularized) wide-azimuth seismic data. With this extension, it is possible to readily access, manipulate and interpret any single fold seismic volume (by fixing offset and azimuth), any offset seismic gather (by fixing azimuth), any single-azimuth seismic gather (by fixing offset), or any other user-defined seismic gather (by defining a path in the offset-azimuth plane). Many Phantom NexusHyperCubes may be derived from one or a few such wide-azimuth NexusHyperCubes.

In some embodiments of the present invention, a sequence of operations may be stored in an XML file, called a processing flow, specified in the modules section of the NexusHyperCube header file. It may consist of valid or permitted processing modules and their parameters. A module is valid if it fulfils any one of the following: (1) single trace operation: operates on one input trace at a time and produces one output trace at a time; (2) Gather operation: operates on one gather at a time and produces one output trace or gather at a time; (3) Domain match: the required input domain (time or depth) matches the output domain of the previous module in a sequence. The input domain of the first module in a sequence must be the same as the domain of the input NexusHyperCube, and the output domain of the last module must be the same as the domain of the Phantom NexusHyperCube; (4) Module parameters: parameters for each module must have no dependency on trace order or trace number in the input NexusHyperCube. Same parameters are applied to every input traces or gathers; and/or (5) Parameter editing: parameters for each module shall be adjustable at any time.

FIG. 3 shows one non-limiting embodiment of a Phantom NexusHyperCube in action. The wide solid lines show data flow and the thin solid lines show command flow. When a Phantom NexusHyperCube is opened, its parent NexusHyperCube(s) is/are also opened and the processing daemon is launched. The daemon sits idle in the background until some data is read. When that happens, the data is first read from the parent NexusHyperCube(s), and then is passed to the daemon for processing (compute). When done, the daemon passes the processed data back to the Phantom NexusHyperCube and which in turn passes the data back to the user. When the Phantom NexusHyperCube is closed, the parent NexusHyperCube is closed first and the daemon is then killed.

For some embodiments that utilize an SMP (symmetric multiprocessing) machine (with multiple CPUs), the daemon and the individual executables in its pipe are most likely running on different CPUs, achieving a concurrent execution automatically. So for those embodiments in which more than two processing modules need to be processed, using the Phantom NexusHyperCube may be faster.

The following Table 1 shows a non-limiting working example of an XML file that defines a complete sequence of processing modules: (1) The first module performs gather mute, with muting defined by a single muting function where offset and z-value pairs are given; (2) The second module converts incoming traces from depth domain to time domain, with output traces sampled at 6 ms and trace length 12 seconds; (3) The third module filters incoming traces with a band pass filter defined by the frequency-amplitude pairs; and/or (4) The fourth module converts incoming traces from time domain back to depth domain, with output traces sampled at 32 ft and trace length 45920 ft.

TABLE 1
Example XML file that defines a complete
sequence of processing modules

```
<?xml version=”1.0” encoding=”ISO  -8859-1” ?>
<modules xmlns:xsi=”http://www.w3.org/2001/XMLSchema  -instance”
                x si:noNamespaceSchemaLocation=
                ”/apps/template/mods.xsd”>
  <module>
```

| | | |
|---|---|---|
| <name> | gmute | </name> |
| <type> | SISO | </type> |

<param name=”survey3d”> /data/xxxx_survey.xml </param>

| | | |
|---|---|---|
| <param name=”htaper”> | 1000.0 | </para m> |
| <param name=”mode”> | Outside | </param> |
| <param name=”mtype”> | function | </param> |

```
    <param name=”zvalues”> 0.0,5000.0,8000.0,15000.0,20000.0
    </param>
    <param name=”offsets”> 0.0,6500.0,7000.0,  900  0.0,20000.0
    </param>
    </module>
    <module>
```

| | | |
|---|---|---|
| <name> | t2d | </name> |
| <type> | SISO | </type> |

| | | |
|---|---|---|
| <param name=”mode”> | d2t | </param> |
| <param name=”dout”> | 6.0 | </param> |
| <param name=”tdmax”> | 12000.0 | </param> |

```
      <param name =”vel3d”> /data/xxxx_sedi_vel3d.xml </param>
    </module>
    <module>
```

| | | |
|---|---|---|
| <name> | filter | </name> |
| <type> | SISO | </type> |

```
      <param name=”frequencies”  > 2.0, 6.0, 22.0, 28.0 </param>
      <param name=”amplitudes”  > 0.0, 1.0,  1.0,  0.0  </param>
    </module>
    <module>
```

| | | |
|---|---|---|
| <name> | t2d | </name> |
| <type> | SISO | </type> |

| | | |
|---|---|---|
| <param name=”mode”> | t2d | </param> |
| <param name=”dout”> | 32.0 | </param> |
| <param name=”tdmax”> | 45920.0 | </param> |

```
      <param name=”vel3d”>  /data/xxxx_sedi_vel3d.xml  </param>
    </module>
</modules>
```

Each processing module has a type, which specifies the flow of traces in the processing pipe. SISO stands for single trace input and single trace output. MISO stands for multiple traces input and single trace output (an example is stack operation). MIMO stands for multiple traces input and multiple traces output. SIMO stands for single trace input and multiple traces output.

The following Table 2 gives the details of each processing module: its characteristics in terms of trace flow, its parameters, and its XML snippet (which completely parameterizes it in a processing flow). The actual list of processing modules is much longer.

TABLE 2

| | Type | Parameters | | XML snippet |
|---|---|---|---|---|
| t2d | SISO | mode | either t2d or d2t | <module> |
| | (single | vel3d | Nexus hybrid velocity model | <param name=”mode”> t2d </param> |
| | trace in | dout | output sampling rate | <param name=”vel3d”> myvel.xml </param> |
| | and single | tdmax | maximum time or depth value | <param name=”dout”> 32.0 </param> |
| | trace out) | | | <param name=”tdmax”> 48000. </param> |
| | | | | </module> |
| d2d | SISO | velref | common reference velocity | <module> |
| | | vel3d | this migration velocity | <param name=”vel3d”> myvel.xml </param> |
| | | | (all nexus hybrid models) | <param name=”velref”> yourvel.xml </param> |
| | | | | </module> |
| gmute | SISO | survey3d | Nexus survey adaptor | <module> |
| | | htaper | Size in ft/m of offset taper | <param name=”survey3d”> survey.xml </param> |
| | | mode | Either outside or inside | <param name=”htaper”> 1000.0 </param> |
| | | mtype | Either function or Voxet | <param name=”mode”> outside </param> |
| | | Voxet | If mtype=Voxet, specify Voxet | <param name=”mtype”> function </param> |
| | | | name | <param name=”Voxet”> my.vo </param> |
| | | volume | if mtype=Voxet, specify volume | <param name=”volume”> hmute </param> |
| | | | name that defines offset mute | <param name=”zvalues”>0,5000,10000</param> |
| | | Zvalues | if mtype=function, give a list of z | <param name=”offsets”>0,5000,10000</param> |
| | | | values | </module> |
| | | offsets | if mtype=function, give a list of | |
| | | | offset values | |
| rmo | SISO | survey3d | Nexus survey adaptor | <module> |
| | | Voxet | Name of input Voxet | <param name=”survey3d”> survey.xml </param> |
| | | property | Name of a property in the Voxet | <param name=”Voxet”> my.vo </param> |
| | | | that contains residual moveout | <param name=”volume”> hmute </param> |
| | | | curvature | <param name=”property”> curvature </param> |
| | | | | </module> |
| stack | MISO | normpow | Normalization power | <module> |
| | (multiple | | Each sample is divided by the | <param name=”normpow”> 1.0 </param> |
| | traces in | | normpow power of non-zero | </module> |
| | and single | | values stacked. | |
| | trace out) | | normpow = 0 : no division | |
| filter | SISO | frequencies | a list of frequencies (e.g., 2, 4, | <module> |
| | | | 25, 32) | <param name=”frequencies”>2,4,20,30 </param> |
| | | amplitudes | a list of amplitudes (e.g., 0.0, 1.0, | <param name=”amplitudes”> 0,1,1,0 </param> |
| | | | 1.0, 0.0) | </module> |
| gain | SISO | tpow | Multiple data by t\hat{ }tpow | <module> |
| | | epow | Multiple data by exp[epow*t] | <param name=”tpow”> 0.0 </param> |
| | | scale | multiple data by scale | <param name=”epow”> 0.0 </param> |
| | | agc | if yes, do AGC | <param name=”scale”> 1.0 </param> |
| | | window_length | length of AGC window in seconds | <param name=”agc”> yes </param> |
| | | positive_clip | clip any data value larger than this | <param name=”window_length”> 0.5 </param> |
| | | | value | <param name=”positive_clip”> 5000 </param> |
| | | negative_clip | clip any data value smaller than | <param name=”negative_clip”> −5000 </param> |
| | | | this value | </module> |

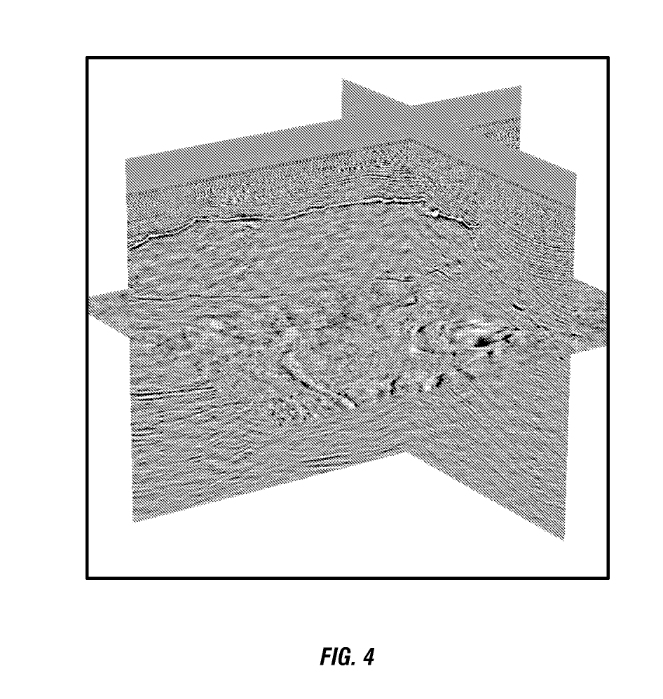

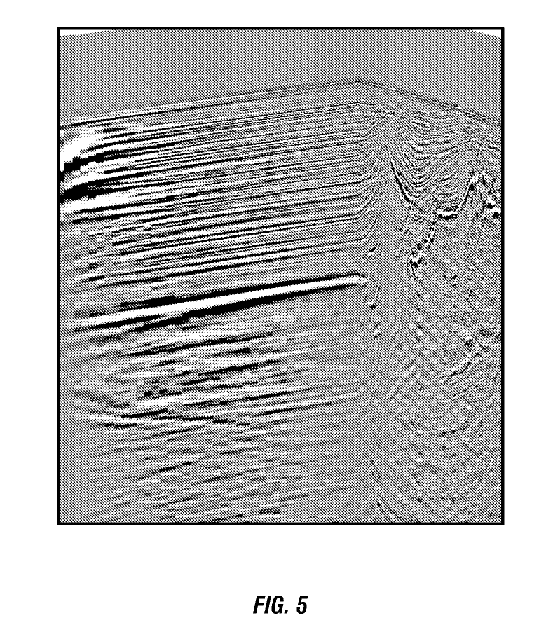

As a non-limiting example, the following Table 3 provides a description of a small dataset from which NexusHyperCubes were created, both as a volume representation, as shown in FIG. 4, and as a gather representation as shown in FIG. 5.

TABLE 3

| | first | last | step | total |
|---|---|---|---|---|
| Inlines | 4549 | 5279 | 2 | 366 |
| Xlines | 4089 | 5485 | 2 | 699 |
| Depth Samples (ft) | 0 | 45920 | ~32 | 1436 |
| Offsets | 1350 | 20538 | 492 | 40 |

| | |
|---|---|
| Total Samples | 14695104960 |
| Data Storage | 16 bits |
| Data Size | ~30 GB |
| Total Size* | ~60 GB |

In non-limiting embodiments, part or all of the models described or implied herein, including but not limited to the NexusHyperCube and the Phantom NexusHyperCube, may be embedded as data structures on one or more computer readable media or transmitted in a propagated signal.

The various methods of the present invention include any one or more or all of the method steps described or implied herein. In further non-limiting embodiments, one or more or all of the steps of any the methods described or implied herein may be described as instructions for execution by an information handling system, and may be stored on one or more computer readable media, transmitted by a propagated signal, or may comprise part of an information handling system.

In other non-limiting embodiments, the computer readable media as described or implied herein may be incorporated into information handling systems.

In even further embodiments, information handling systems are envisioned which include a processor, computer readable media comprising the above described data structures or instructions, wherein the media is accessible by the processor, and wherein the processor may carry out the instructions.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A data structure embedded in computer readable media, for 4D+ prestack seismic data, the structure comprising:
Volume fields containing data indicative of individual single fold 3-D volumes;
Gather fields associated with the volume fields, and containing data indicative of 3-D prestack gathers; and
Mapping table fields containing data for linking the volume fields and the gather fields, and for maintaining coherency between the volume fields and the gather fields.

2. The data structure of claim 1, further comprising:
Header table fields containing data indicative of additional dimensions for the volume fields and the gather fields.

3. The data structure of claim 2, wherein the additional dimensions are selected from the group consisting of acquisition offset, acquisition azimuth, reflection angle, reflection azimuth, time stamps, data vintages, acquisition offset-acquisition azimuth pair, reflection angle- reflection azimuth pair, or time stamp-offset pair.

4. The data structure of claim 1, further comprising:
Survey adaptor fields associated with the volume fields and the gather fields, containing data indicative of instructions for converting among global coordinate (geographic coordinate), local coordinate (processing coordinate), and user coordinate (interpreter's inline and crossline numbers)

5. The data structure of claim 1, further comprising:
Scalar table fields associated with the volume fields and the gather fields containing data to allow amplitude recovery for 4D+ seismic data stored with reduced precision.

6. The data structure of claim 1, further comprising:
Header block fields associated with the volume fields and the gather fields containing data indicative of the dimensions, size, and characteristics of the 4D+ prestack seismic data.

7. The data structure of claim 1, further comprising:
Interface function fields associated with the volume fields and the gather fields containing a set of interface functions to process the volume fields and the gather fields.

8. The data structure of claim 7, wherein the interface functions comprise functions to read, write or update the 4D+ prestack seismic data.

9. The data structure of claim 1 wherein the 4D+ prestack seismic data comprises wide-azimuth seismic data.

10. The data structure of claim 9, wherein the 4D+ prestack seismic data is selected from the group consisting of migrated wide-azimuth seismic data, and unmigrated wide-azimuth seismic data.

11. The data structure of claim 1, further comprising a phantom structure comprising:
A flag field containing data indicating the structure as a phantom;
A pointer field containing data indicative of an association with a second 4D+ prestack seismic data comprising second volume fields, second gather fields, and second mapping table fields;
Shell fields containing data indicative of a description of the phantom structure; and,
Ordered operation fields containing data indicative of ordered operations for generating data of the phantom structure.

12. A data structure embedded in computer readable media, for 4D+ prestack seismic data, the structure comprising:
A flag field containing data indicating the data structure as a phantom;
A pointer field containing data indicative of an association with at least one 4D+ prestack seismic data set;
Shell fields containing data indicative of a description of the data structure; and,
Ordered operation fields containing data indicative of ordered operations for generating data of the data structure from the at least one 4D+ prestack seismic data set.

13. The data structure of claim 12, wherein the at least one 4D+ prestack seismic data set may comprise at least one phantom data set, at least one non-phantom data set, or at least one phantom data set and at least one non-phantom data set.

14. A computer implemented method of processing 4D+ prestack seismic data, wherein the data comprises individual single fold 3-D volumes, 3-D prestack gathers, and mapping data for linking the volumes and the gathers and for maintaining coherency between the volumes and gathers, the method comprises:
carrying out at least one processing operation on the 4D+ prestack seismic data.

15. The computer implemented method of claim 14, wherein the processing operation is selected from the group consisting of signal processing operations and non-signal processing operations.

16. The computer implemented method of claim 15, wherein the signal processing operations comprise any mathematical operation, and the non-signal processing operations comprise at least one selected from the group consisting of copying, viewing, writing, displaying, transferring, picking, printing, extracting, cutting, splicing, or marking.

17. A computer implemented method of processing 4D+ prestack seismic data, wherein the data comprises:
A flag indicating the data as phantom;
A pointer to at least one 4D+ prestack seismic data set;
A description of the data structure; and,
Ordered operation for generating data from the at least one 4D+ prestack seismic data set,
the method comprises:
carrying out at least one processing operation on the 4D+ prestack seismic data.

18. The computer implemented method of claim 17, wherein the processing operation is selected from the group consisting of signal processing operations and non-signal processing operations.

19. The computer implemented method of claim 18, wherein the signal processing operations comprise any mathematical operation, and the non-signal processing operations comprise at least one selected from the group consisting of copying, viewing, writing, displaying, transferring, picking, printing, extracting, cutting, splicing, or marking
